(19) United States
(12) Patent Application Publication
(10) Pub. No.: US 2004/0041447 A1
(43) Pub. Date: Mar. 4, 2004

(54) Floor protector dispenser

(76) Inventor: Carolyn Tortorice, Houston, TX (US)

Correspondence Address: R. PERRY MCCONNELL, P.C., 9001 FOREST CROSSING, SUITE F, THE WOODLANDS, TX, 77381, US

(21) Appl. No.: 10/229,403

(22) Filed: Aug. 28, 2002

(51) Int. Cl. A47C 7/62; B65H 1/00; B65G 59/00

(52) U.S. Cl. 297/188.08; 221/1

(57) ABSTRACT

The disclosure describes a means of conveniently dispensing temporary floor coverings for use in homes or restaurants to allow rapid cleaning of spills around infant high chairs, without interfering with any of the normal functions or attributes of the high chair.

### FIELD OF THE INVENTION

The invention provides a means of conveniently dispensing temporary floor coverings for use in homes or restaurants to allow rapid cleaning of spills around infant high chairs.

### BACKGROUND OF THE INVENTION

Infant high chairs, or at least the normal occupants thereof, are a notorious source of debris, fluid, and other material which may surround the high chair, stain the flooring material beneath, and create an ongoing need to clean the area. These problems can be especially pronounced in restaurants, where high chairs are often positioned on carpeting and in high foot-traffic areas, thus exacerbating the likelihood of stains, tracking of fluid and debris into nearby areas, and ground-in debris which is difficult to remove. It is accordingly desirable to provide protective mats, or floor coverings, under these high chairs to catch most, if not all, of the detritus cast from above. Such a floor covering should be lightweight, inexpensive, disposable, and readily at hand when needed.

However, available floor mats intended for such use are not easily adaptable to restaurant applications. Several heavy-weight plastic sheet mats are commercially sold as floor protectors for use under infant high chairs. These mats are relatively expensive, are intended for long-term use, and would have to be cleaned repeatedly if used in a restaurant environment. Due to their weight and size, they would generally have to be carried through the restaurant separately from the high chair, and would have to be picked up and carried carefully after use to a place where they could be cleaned.

Similarly, heavy weight paper, such as butcher paper, could be used, but due to its weight would most likely have to be maintained on rolls in a central location, torn off in sheets, and carried through the restaurant to the desired location. Further, paper is a less than ideal material for absorbing or blocking liquid spills. Moreover, the tendency of such paper to tear relatively easily would increase the likely hood that debris would simply fall through a tear and remain behind when the “shield” was removed.

Disposable floor covering mats have been suggested by others, but their relative complexity, which translates to expense and less ease of handling, preclude their ready use in restaurants. For example, U.S. Pat. No. 4,483,895 to Deaver (“the '895 patent”) discloses a disposable apron for use beneath an infant high chair. The apron comprises a liquid impervious sheet, which is preferably a thin, flexible, polyethylene film in combination with a liquid-absorbent layer which is bonded to the polyethylene sheet. The apron so disclosed may be effective, but its two-layer, bonded construction requires manufacturing expense which would translate to higher costs for a restaurant owner.

Similarly, U.S. Pat. No. 4,328,275 to Vargo (“the '275 patent”) discloses a multi-layer, disposable floor mat. The device of the '275 patent is intended to maintain a dry top layer, while absorbing liquid into an intermediate layer. As with the '895 patent, the floor-contact layer is liquid impermeable, and is preferably a polyethylene or polyester film, such as mylar. Again, such a mat is inappropriate as a low-cost solution.

A second problem in providing floor coverings for ready use in restaurants is the ability to deliver the mat to the desired location of use. If a disposable mat is available from a single dispenser, someone must move not only the high chair to the desired location, but also must trek to the dispenser to obtain a mat. Because the mat must be sufficiently large when spread out to cover the floor in the immediate vicinity of the high chair, it may be impossible to practically transport the high chair and the mat at the same time.

If the floor coverings are made sufficiently light-weight to allow a dispenser to be attached to the high chair, the dispenser should not create new problems. For example, the dispenser should not extend beyond the existing structure of the high chair and thereby create an extra obstacle for passing patrons and waiters. Similarly, because many restaurant-style high chairs are designed to be stackable for space-savings, the location of such a portable dispenser should not interfere with the stacking feature.

Accordingly, it is an object of the invention to provide a portable dispenser for lightweight, disposable floor coverings which can be transported easily with an infant high chair, making the floor coverings readily available at the point of use. It is a further object of the invention to provide a dispenser which does not interfere with traffic around the high chair, and does not interfere with other design features of such chairs, such as stackability.

### SUMMARY OF THE INVENTION

The invention comprises a container which is securable to a high chair, preferably to the underside of the seat of the chair. For stackable high chairs, the height profile of the container is preferably small enough to allow the chairs to be stacked in the same manner as always, thus allowing continued use of the chairs in the normal manner (e.g., stacked for storage) while providing a container location which is conveniently out of the way, yet with the chair at all times. Thus, the container will not create any additional traffic hazards in areas with high foot traffic which would not exist if the chair were there, anyway, and at the same time provide a convenient location for the dispensing of temporary floor coverings.

The container further comprises an opening, such as a slot, in the bottom or in one side, through which disposable, temporary floor coverings can be dispensed. In the preferred embodiment, the floor coverings used will be thin plastic sheets which are pre-cut to a size sufficient to cover the area underneath the high chair and within a reasonable perimeter thereof. These floor coverings can be manufactured in a pre-perforated roll, one end of which can be fed through the opening to allow dispensing of the floor coverings, or in a folded configuration, allowing one to reach into the opening and withdraw the next available sheet. In this manner, the container can be large enough to contain a useful number of floor coverings, reducing the need to re-fill the container, while still remaining light enough to allow the high chair to be easily carried about the restaurant.

Preferably, the container will comprise an openable panel through which it can be refilled. Alternatively, one side, or an otherwise sufficient opening can be left open at all times, although an openable panel will be preferred for esthetic reasons and to keep dirt and other debris out of the interior.

The container may be attached to the high chair through a number of devices, for example, straps, velcro, screws, nails, glue, etc. Those of skill in the art will recognize that a variety of attachments can be used without departing from the spirit of the invention, so long as the container is securely attached to the high chair without the risk of either it, or its contents, departing from their desired location as the high chair is moved about.

Utilizing this invention, one can position the high chair proximate its desired location, reach to the container, pull out a floor covering, place the floor covering flat on the floor, and place the high chair on top of the floor covering. When the meal is done, the high chair can be removed and the disposable (and presumably besplattered) floor covering can be wadded up and thrown away, together with its content.

### BRIEF DESCRIPTION OF THE DRAWINGS

FIG. 1A is a side view of a high chair with one embodiment of the invention.

FIG. 1B is a side view of multiple prior art high chairs in a stacked formation.

FIG. 1C is a side view of multiple high chairs in a stacked formation with one embodiment of the invention.

### DETAILED DESCRIPTION

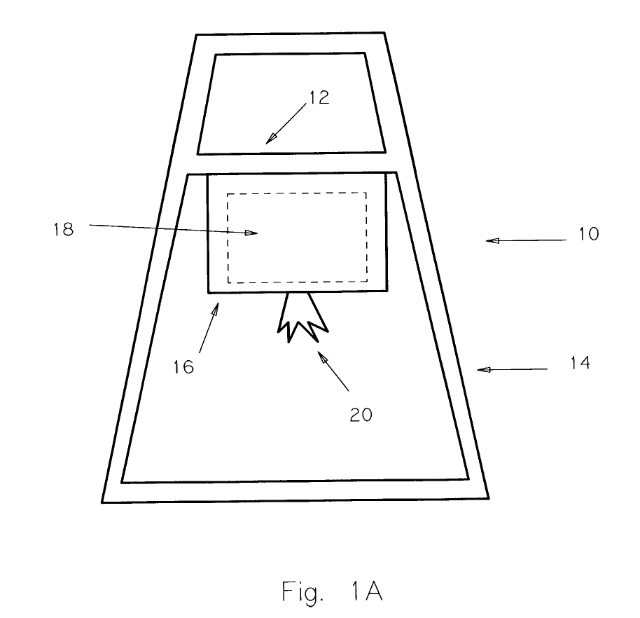

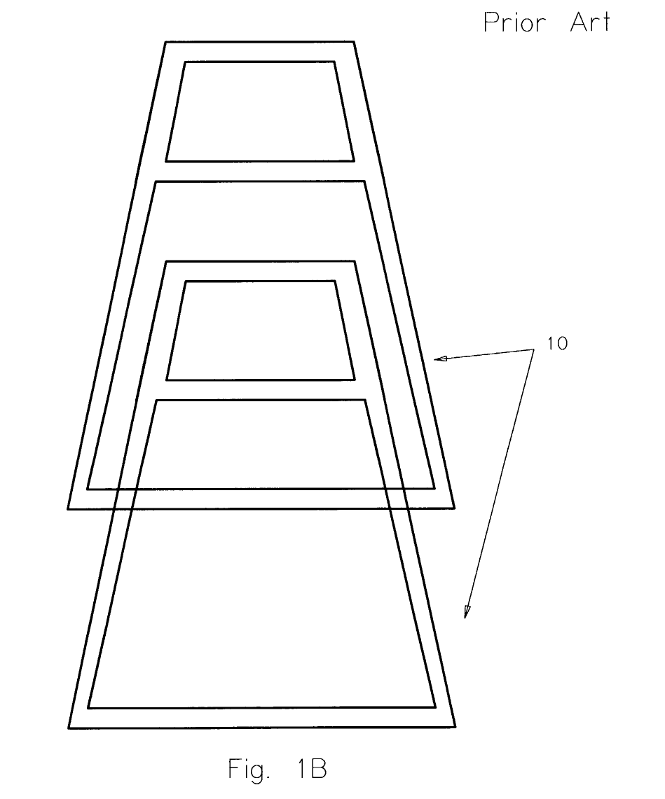

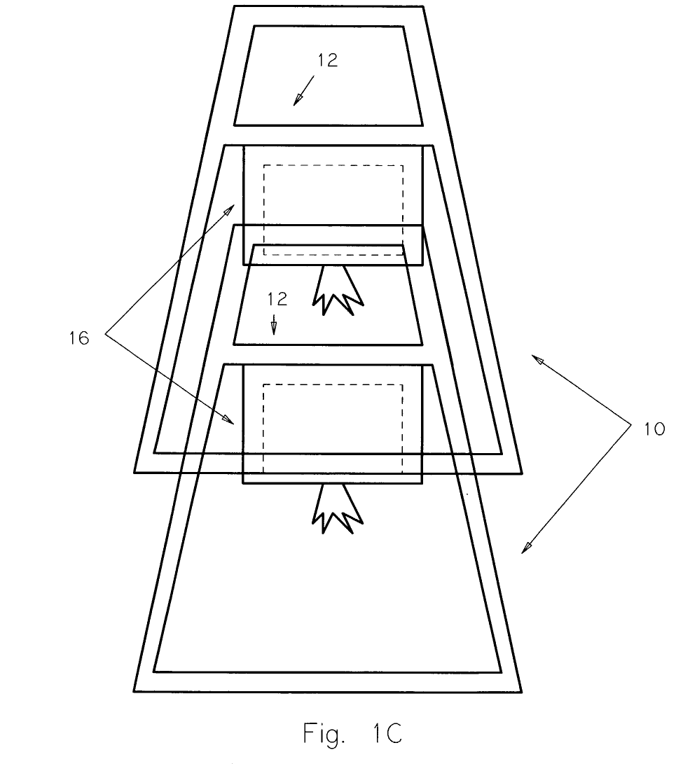

Referring to FIG. 1A, a side view of a representative high chair with the invention attached is shown. A high chair 10 comprises a seat 12 and leg 14. Beneath the seat is attached a container 16 which is attached to the underside of the seat 12. Inside the container is a roll or refill container of floor coverings 18. Through a slot (not shown) in the container 16, the leading edge of the next available floor covering 20 extends, and is available to be pulled out and used. The container 16, is attached to the underside of the seat 12 through any of a variety of devices, such as straps, screws, velcro, nails, glue, or, as those of skill in the art will recognize, any other fastening or adhesive device which lends itself to securely fastening the container 16 securely and with sufficient strength to support the weight of the container 16 and the floor coverings 18.

Refills of the floor coverings 18 may be inserted into the container 16 by leaving one side of the container 16 open, or preferably by making an openable panel (not shown) in one of the sides or the bottom of the container 16. Alternatively, the container 16 could be detached from the high chair 10, although this approach would not be preferred due to the unnecessary additional steps required to detach and re-attach the container 16.

Referring to FIGS. 1B and 1C, side views of representative high chairs in stacked formation are shown, respectively without and with the attached invention. As depicted in FIG. 1B, the high chairs 10 are designed to be stackable to conserve floor space when the chairs are not in use. As depicted in FIG. 1C, the spacing between the seats of the high chairs 10, allows the container 16 to be attached to the underside of the seats 12, without disturbing the ability of the chairs 10 to be stacked. Thus, the containers 16 allow the invention to be practiced without interfering in the normal use of the high chairs 10, and without creating any additional traffic obstructions.

I claim:

1. A dispenser for temporary floor protectors for infant high chairs, comprising
a container, wherein said container is attachable to a high chair beneath the seat thereof, and wherein said container comprises an opening through which temporary floor protectors are dispensable.

2. The device of claim 1, wherein said container additionally comprises a selectably openable panel.

3. The device of claim 2, wherein said selectively openable panel is positioned on the side of said container.

4. The device of claim 2, wherein said selectively openable panel is positioned on the bottom of said container.

5. A method of dispensing temporary floor protectors for use under infant high chairs, comprising the steps of
attaching a dispenser to the underside of a high chair seat,
inserting a plurality of temporary floor protectors into said dispenser, and
selectively removing temporary floor protectors from said dispenser.
